(19) United States
(12) Patent Application Publication
(10) Pub. No.: US 2009/0073607 A1
(43) Pub. Date: Mar. 19, 2009

(54) Reduction in Particle Rebound Off of Component Surfaces

(75) Inventors: Ning Yu, Eden Prairie, MN (US); Yimin Niu, Eden Prairie, MN (US)

Correspondence Address: SEAGATE TECHNOLOGY LLC C/O WESTMAN;CHAMPLIN & KELLY, P.A., SUITE 1400, 900 SECOND AVENUE SOUTH, MINNEAPOLIS, MN, 55402-3244, US

(73) Assignee: SEAGATE TECHNOLOGY LLC, Scotts Valley, CA (US)

(21) Appl. No.: 11/857,526

(22) Filed: Sep. 19, 2007

(51) Int. Cl. G11B 33/14; A47B 81/00; G06F 1/16

(52) U.S. Cl. 360/97.02; 312/223.2; G9B/33.035

(57) ABSTRACT

An enclosure system includes an enclosure and at least one rotating storage medium positioned within the enclosure. The enclosure has a corresponding airflow contaminated with particles. An impact absorbing material is deposited on at least one component in the enclosure and positioned within and traversely to the airflow. The impact absorbing material is configured to reduce rebound velocity of the particles off of the at least one component in the enclosure.

### BACKGROUND

Disc drives are common data storage devices. A typical disc drive includes a rigid housing that encloses a variety of disc drive components. The components include one or more discs having data surfaces that are coated with a medium for storage of digital information in a plurality of circular concentric data tracks. The disc(s) are mounted on a spindle motor that cause the disc(s) to spin and the data surfaces of the disc(s) to pass under aerodynamic bearing disc head sliders. The sliders carry transducers, which write information to and read information from the data surfaces of the discs.

One of the more prevalent reliability issues in disc drives are media failures caused by particles that contaminate the airflow in the housing of the disc drive. The more recent introduction of perpendicular recording compared to its longitudinal recording counterpart has further aggravated the problem. Perpendicular recording requires media that has a higher sensitivity to scratch compared to media used with longitudinal recording.

One of the more common types of media failures due to particles includes the impact of particles, especially large sized particles, on a disc surface of the media. Such impact can scratch and cause damage to the integrity of recorded data on the media. Oftentimes, the impact of particles on the media can occur after particles rebound off of disc drive components within the housing of the disc drive.

### SUMMARY

A data storage system encloses at least one rotatable data storage medium, a plurality of internal data storage system components and impact absorbing material. The at least one rotatable data storage medium has a corresponding airflow that is contaminated with particles. Each internal data storage system component includes component surfaces that are located in proximity to the at least one rotatable data storage medium and within the contaminated airflow. The impact absorbing material is deposited on the surface of one of at least one of the internal data storage system components. The impact absorbing material reduces rebound velocity of the particles in the airflow off of the surface of the at least one of the internal data storage system components.

These and various other features and advantages will be apparent from a reading of the following Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a plan view of a disc drive.

FIG. 2A illustrates a schematic diagram of a prior art surface of a component.

FIGS. 2B and 2C are schematic diagrams of embodiments of surfaces of components under one embodiment.

FIG. 3 is a schematic illustration of a shroud wall and separator plate under one embodiment.

FIG. 4 is a plan view of a data storage device including an actuator mechanism under one embodiment.

FIG. 5 is a perspective view of flow control components under one embodiment.

FIG. 6 is a perspective view of a filter assembly under one embodiment.

### DETAILED DESCRIPTION

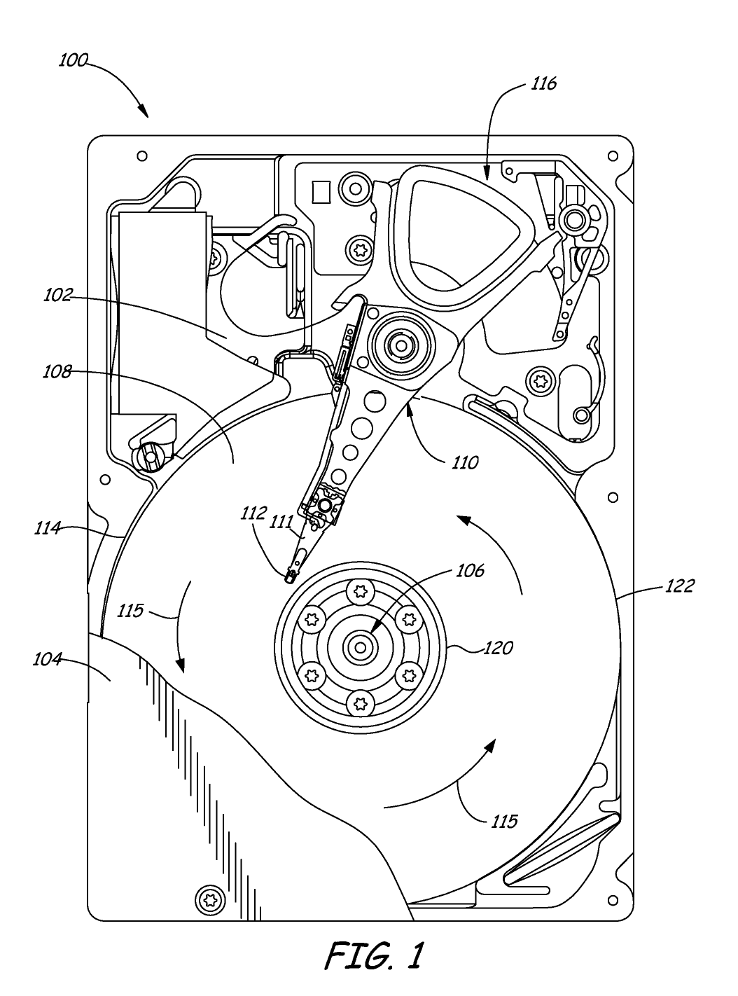

While the claimed invention has utility in any number of different applications, FIG. 1 has been provided to illustrate a particularly suitable environment in which the claimed invention can be advantageously practiced. FIG. 1 illustrates a top plan view of a disc drive 100. Disc drive 100 is one example of a data storage device of the type configured to magnetically store and transfer digital data with a host device. Disc drive 100 includes a base 102 which mates with a top cover 104 (shown in partial cut-away) to form a sealed housing.

Disc drive 100 includes a plurality of disc drive components. In particular, disc drive 100 includes at least one disc or storage medium 108, which is mounted on a spindle motor 106. In some embodiments, there can be two or more discs or media. Regardless of the quantity of discs, each disc surface has an associated disc head slider 112. In FIG. 1, sliders 112 are supported by suspensions 111, which are in turn attached to an actuator mechanism 110. The actuator mechanism 110 shown in FIG. 1 is of the type known as a rotary moving coil actuator and includes a voice coil motor (VCM), shown generally at 116.

Voice coil motor 116 rotates actuator mechanism about a pivot shaft to position sliders 112 over a desired data track along an arcuate path between a disc inner diameter 120 and a disc outer diameter 122. Base 102 includes a shroud wall 114 that surrounds at least one disc 108 and is spaced apart from outer diameter 122 of disc(s) 108. The rotation of disc(s) 108 induces significant airflow within base 102 in the same general rotational direction 115. This airflow can contain harmful particle contaminants.

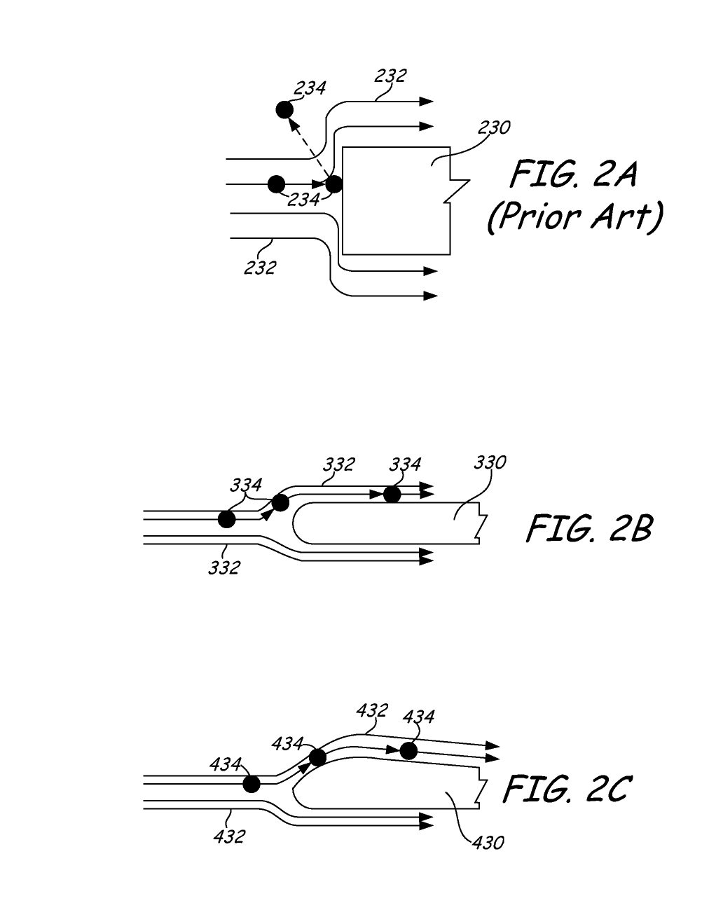

FIG. 2A illustrates a schematic diagram of a disc drive component 230 positioned in an airflow 232 induced by a rotating disc in a disc drive in accordance with the prior art. As illustrated, component 230 has sharp, right angled edges in which airflow 232 has to direct itself around. As illustrated, a particle 234 is contaminating airflow stream 232. Since the mass of particle 234 is high, particle 234 has a large momentum. Such a large momentum causes particle 234 not to be able to follow flow stream 232 well, especially in this situation where the flow stream takes sharp corners. As illustrated in FIG. 2A, instead of particle 234 following flow stream 232, particle 234 impinges on a surface of component 230. After impinging on the surface of component 230, as illustrated, particle 234 rebounds away from component 230. If the velocity of particle 234 is high, rebounding particle 234 can cause significant damage. In particular, if rebounding particle 234 is directed towards the medium of a data storage device, particle 234 can cause significant damage to the medium.

To reduce large sized particles from impinging on and therefore rebounding off components in a data storage system, the profile of components in the data storage system are modified. In one embodiment, FIG. 2B illustrates a schematic diagram of a disc drive component 330 as it is positioned in an airflow 332 induced by a rotating disc in a disc drive. For example, component 330 can be actuator mechanism 110 (FIG. 1), shroud wall 114 (FIG. 1) or other type of disc drive component. As illustrated, component 330 has rounded edges in which airflow stream 332 directs itself around. As illustrated, a particle 334 is contaminating airflow stream 332. The rounded edges of component 330 provides airflow stream 332 with a slow change in flow line compared to the squared edge component 230 of FIG. 2B. A slow change in flow line improves the chance that particle 334 will bypass component 330 by staying in the fluid flow, instead of impinging and therefore rebounding off its surface.

In another embodiment, FIG. 2C illustrates a schematic diagram of a disc drive component 430 as it is positioned in an airflow 432 induced by a rotating disc in a disc drive. For example, component 430 can be actuator mechanism 110 (FIG. 1), shroud wall 114 (FIG. 1) or other type of disc drive component. As illustrated, component 430 has wing-shaped edges in which airflow stream 432 directs itself around. As illustrated, a particle 434 is contaminating airflow stream 432. The wing-shaped edges of component 430 provides airflow stream 432 with a slower change in flow line compared to both the squared edge component 230 of FIG. 2B and the rounded edge component 330 of FIG. 2C. A slower change in flow line improves particle 434 with a chance to bypass component 430 instead of impinging and therefore rebounding off its surface.

In another aspect, an impact absorbing material can be applied to various components in a disc drive to reduce large sized airborne particles from rebounding off component surfaces and damaging the media. An impact absorbing material reduces rebounding of particles by reducing the kinetic energy of the particles and causing particles to no longer be airborne. In one embodiment, the impact absorbing material can include surface features for better reducing the impact energy of particles. In one embodiment, the impact absorbing material can include a compliant surface that can either be the material itself or a thin compliant layer. It should be noted that although a compliant surface can be included in the material, the impact absorbing properties of the material should be as close to the surface as possible because the effect of particle impact is generally not from deep within the material. In one example, impact absorbing material can be a viscoelastic material. Alternatively, impact absorbing material can be a viscoelastic material having a soft surface coating to further prevent high velocity rebound or a porous surface. This porous surface includes apertures that have sizes greater than the size of particles in the airflow. In addition, impact absorbing material can include a select material having a viscoelastic material coating.

In yet another aspect, a particle capture material can be applied to various components in a disc drive to collect airborne particles. In one embodiment, like the impact absorbing material, the particle capture material can include a compliant surface. The particle capture material can also include surface features for capturing particles. For example, surface features can include a honeycomb pattern having holes of the size slightly larger than a size of the airborne particles or a fibrous or membrane surface layer. In addition, particle capture material can be a viscoelastic material having an adhesive material coating for trapping particles or a viscoelastic material having porous layers, such as various filtration materials. In another embodiment, particle capture material can include a non-outgas adhesive material. For example, the adhesive material can be a pressure-sensitive adhesive.

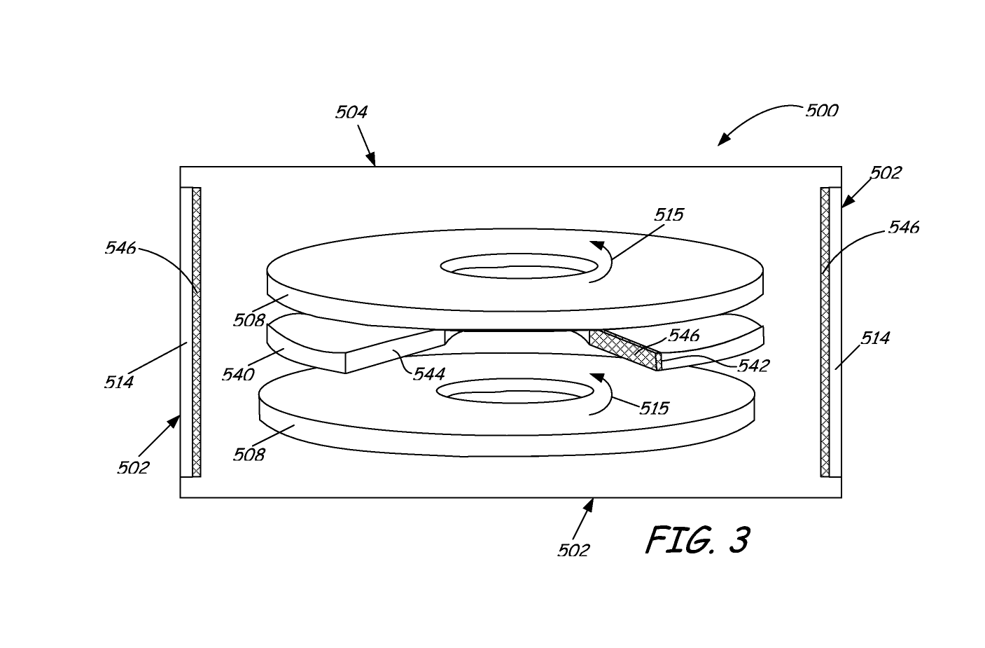

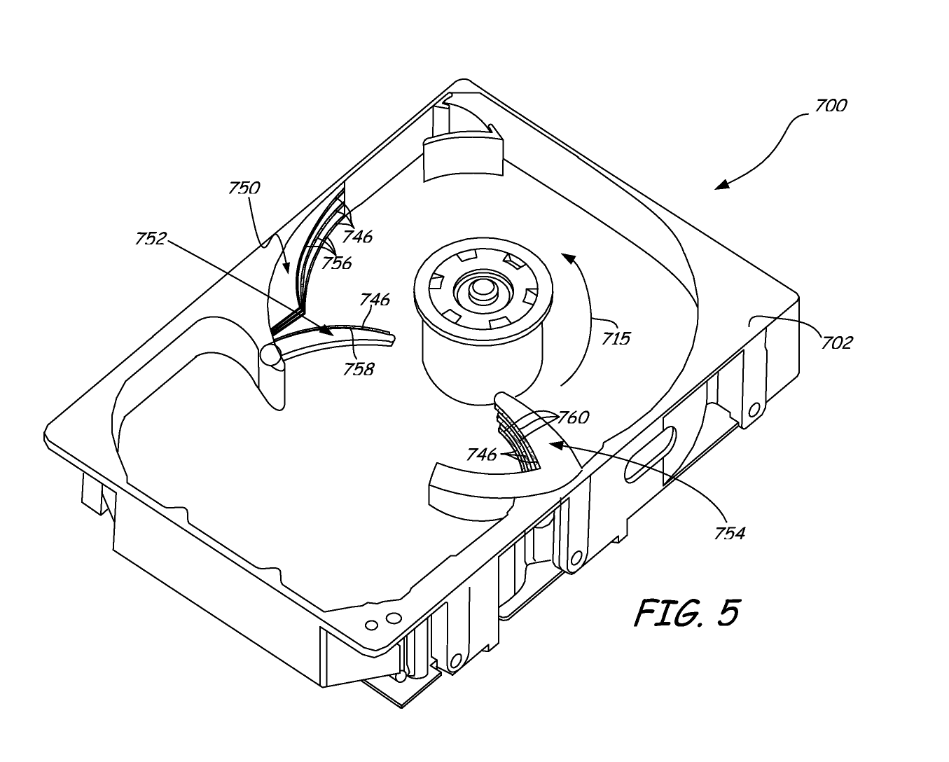

FIG. 3 illustrates a schematic section view of a disc drive 500 under one embodiment. Disc drive 500 includes a base 502 and a top cover 504 which forms a housing. Disc drive 500 also includes media 508 surrounded by a shroud wall 514. Shroud wall 514 is spaced radially outward from an edge or outer diameter of media 508. Each medium 508 rotates in a direction 515 and are separated from each other by a separator plate 540. It should be understood that in one embodiment, disc drive 500 can include a single medium 508. It should also be understood that in one embodiment, disc drive 500 can include more media than that which is illustrated in FIG. 5. In such an embodiment, separator plates would be interposed among and adjacent the various disc surfaces each media 508. Separator plate 540, also referred to as a windage plate, is utilized to effect head positioning control during operative and deactivated modes of disc drive 500. Separator plate 540 includes a leading edge 542 and a trailing edge 544. In between leading edge 542 and trailing edge 544, separator plate 540 accommodates movement of an actuator mechanism, such as actuator mechanism 110 (FIG. 1). Therefore, leading edge 542 is located downstream from an actuator mechanism and trailing edge 544 is located upstream from an actuator mechanism.

To reduce particle rebound off shroud wall 514 and separator plate 540, disc drive 500 includes impact absorbing material or particle capture material 546. Material 546 is deposited on or applied to surfaces of shroud wall 514. As also illustrated in FIG. 5, material 546 is deposited on or applied to a surface of leading edge 542 of separator plate 540. In particular, material 546 is deposited on or applied to a surface of leading edge 542 that is an upstream surface of separator plate 540 and positioned both within and traversely to the airflow. Airflow circulates throughout disc drive 500 in a similar direction as direction 515 of media 508. Therefore, particles will tend to impinge on an upstream surface of separator plate 540 compared to the surface of trailing edge 544, which is a downstream surface of separator plate 540.

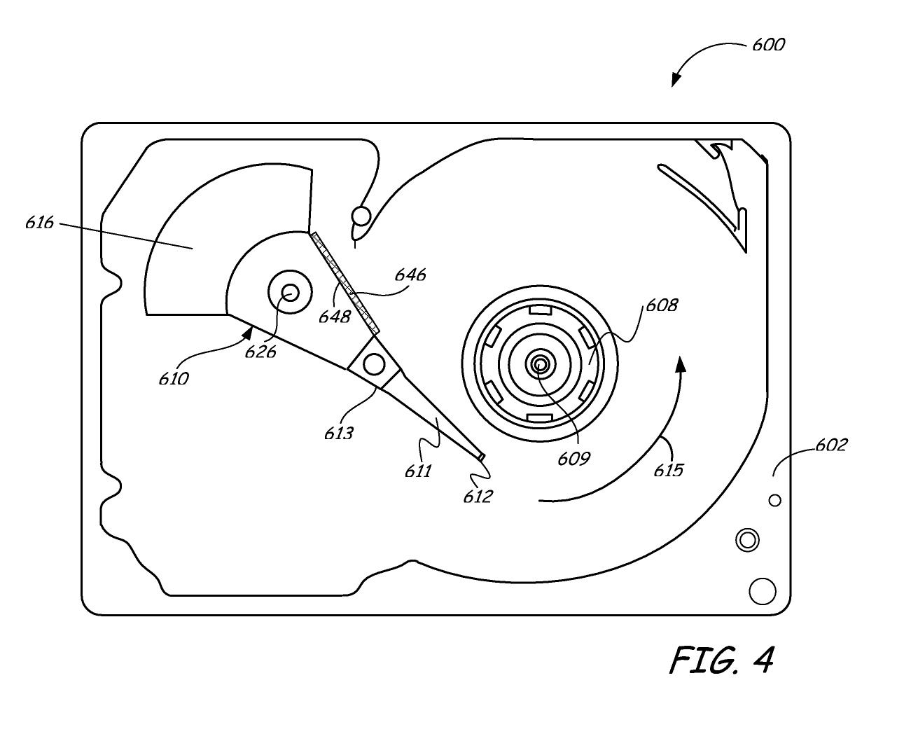

FIG. 4 is a plan view of base 602 of a disc drive 600. Base 602 is configured for incorporation into a data storage system. For example, base 602 can be substituted for base 102 within disc drive 100 (see FIG. 1). When disc drive 600 is operational, the media (not shown in FIG. 4) are configured to rotate about central axis 609 and are secured to base 602 by disc clamp 608. The rotation of the discs in the rotational direction 615 induces an airflow. Base 602 includes an actuator mechanism 610. The actuator mechanism 610 has a slider 612 supported by a suspension 611 which is in turn attached to a track accessing arm 613. Actuator mechanism 610 is rotated about a shaft 626 by a voice coil motor 616. Actuator mechanism 610 is configured to position slider 612 relative to a medium.

To reduce particle rebound off of actuator mechanism 610, disc drive 600 includes impact absorbing material or particle capture material 646. Material 646 is deposited on or applied to a surface of actuator mechanism 610. In particular, material 646 is deposited on or applied to a surface of actuator mechanism that is an upstream surface 648 and positioned both within and traversely to the airflow. As airflow circulates throughout disc drive 600 in the rotational direction 615 of the media, particles will tend to impinge on upstream surface 648 of actuator mechanism 610 compared to other surfaces of actuator mechanism 610.

FIG. 5 illustrates a perspective view of a base 702 of a disc drive 700 having a plurality of flow control components. The media of disc drive 700 has been removed to illustrate various components in more detail. These flow control components are configured to mitigate disturbances in airflow and attenuate vibration within the disc drive. Flow control components are not limited by, but can include: upstream air dam 750, upstream air vane 752 and downstream air dam 754. Upstream air dam 750, upstream air vane 752 and downstream air dam 754 are positioned adjacent media. Although upstream air dam 750 and downstream air dam 754 illustrate a plurality of fins having upstream surfaces, it should be realized that air dams 750 and 754 can have more or less fins depending on the quantity of media that are placed in disc drive 700. For example, if only a single medium is placed in disc drive 700, then air dams 750 and 754 would only need one or two fins.

To reduce particle rebound off of flow control components illustrated in FIG. 5, disc drive 700 includes impact absorbing material or particle capture material 746. In FIG. 5, material 746 is applied to various surfaces of each flow control component. In one embodiment, material 746 is deposited on or applied to upstream surfaces 756 of upstream air dam 750. In another embodiment, material 746 is deposited on or applied to an upstream surface 758 of upstream air vane 752. In yet another embodiment, material 746 is deposited on or applied to leading edge surfaces 760 of downstream air dam 754. As airflow circulate throughout disc drive 700 in the rotation direction 715 of the media, particles will tend to impinge on upstream surfaces 756, upstream surface 758 and leading edge surface 760 of the flow control components illustrated in FIG. 7. Material 746 is deposited on or applied to these surfaces to absorb particle impact by preventing particle rebound or capturing the particles.

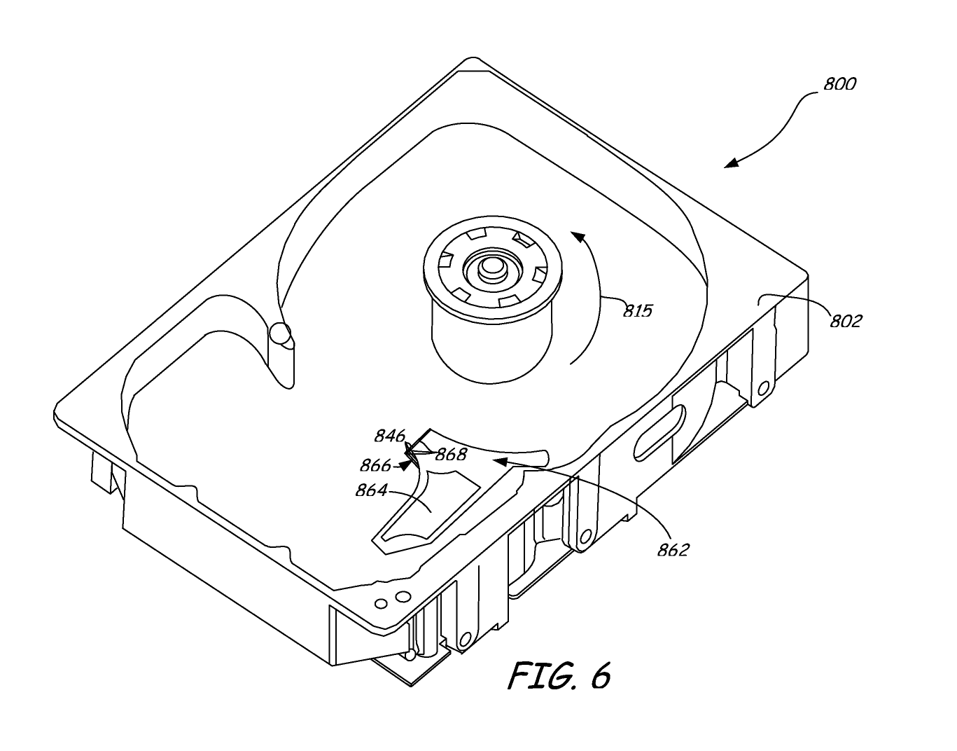

FIG. 6 illustrates a perspective view of a base 802 of a disc drive 800 having a filter assembly device 862. Assembly 862 includes a first flow passage or recirculation flow passage (hidden from view in FIG. 6) having an inlet and outlet. In general, a recirculation filter is disposed in the first flow passage for filtering debris. Assembly 862 also includes a second flow passage (hidden from view in FIG. 6) open to ambient and open to the first flow passage. A breather filter is interposed in the second flow passage for filtered ambient air exchange. Assembly 862 also includes desiccant 864. The first flow passage includes a plurality of flow plates 866 disposed therein for streamline flow. The flow plates 866 are coupled to the body of the assembly 862 to form flow fins aligned with edges of the disc surface to reduce flow turbulence through the first flow passage and to enhance flow and filter efficiency. Fins 866 include upstream surfaces 868.

In one embodiment, impact absorbing material or particle capture material 846 is applied to upstream surface 868. As airflow circulate throughout disc drive 800 in the rotation direction 815 of the media, particles will tend to impinge on upstream surfaces 868 of flow plate 866. Material 846 is applied to these upstream surfaces to absorb particle impact by preventing particle rebound or capturing the particles.

It is to be understood that even though numerous characteristics and advantages of various embodiments of the disclosure have been set forth in the foregoing description, this disclosure is illustrative only, and changes may be made in detail, especially in matters of structure and arrangement of parts within the principles of the disclosure to the full extent indicated by the broad general meaning of the terms in which the appended claims are expressed. For example, the particular elements may vary depending on the particular application of impact absorbing material while maintaining substantially the same functionality without departing from the scope and spirit of the disclosure. In addition, although the embodiments described herein are directed to a disc drive, it will be appreciated by those skilled in the art that the teachings of the disclosure can be applied to other types of data storage systems, without departing from the scope and spirit of the disclosure.

What is claimed is:

1. An enclosure system comprising:
an enclosure;
at least one rotating storage medium positioned within the enclosure and having a corresponding airflow contaminated with particles; and
an impact absorbing material deposited on at least one component in the enclosure and positioned within and traversely to the airflow, the impact absorbing material configured to reduce rebound velocity of the particles off of the at least one component in the enclosure.

2. The enclosure system of claim 1, wherein the at least one component comprises a shroud wall that is spaced radially outward from an edge of the at least one rotating storage medium, wherein the impact absorbing material is deposited on at least a portion of the shroud wall.

3. The enclosure system of claim 1, wherein the at least one component comprises an actuator mechanism configured to position a transducing head relative to the at least one storage medium, wherein the impact absorbing material is deposited on an upstream surface of the actuator mechanism.

4. The enclosure system of claim 1, wherein the at least one component comprises an at least one storage medium separator plate positioned adjacent the at least one rotating storage medium and including a leading edge surface located downstream from an actuator mechanism configured to position a transducing head relative to the at least one storage medium, wherein the impact absorbing material is deposited on the leading edge surface.

5. The enclosure system of claim 1, wherein the at least one component comprises an upstream air dam feature positioned adjacent the at least one rotating storage medium and including at least one upstream surface, wherein the impact absorbing material is deposited on the upstream surface of the upstream air dam feature.

6. The enclosure system of claim 1, wherein the least one component comprises a downstream air dam feature positioned adjacent the at lest one rotating storage medium and including a leading edge surface and a trailing edge surface, wherein the impact absorbing material is deposited on the leading edge surface of the downstream air dam feature.

7. The enclosure system of claim 1, wherein the at least one component comprises a filter assembly having a plurality of flow plates having upstream surfaces disposed in a recirculation flow passage, wherein the impact absorbing material is deposited on the upstream surfaces of the flow plates.

8. The enclosure system of claim 1, wherein the impact absorbing material comprises a viscoelastic material.

9. The enclosure system of claim 1, wherein the impact absorbing material comprises a porous surface to further reduce rebound velocity of the particles off of the at least one component in the enclosure.

10. The enclosure system of claim 9, wherein the porous surface comprises apertures that have greater sizes than sizes of the particles.

11. A data storage system comprising:
an enclosure;
a rotatable data storage medium positioned within the enclosure and having a corresponding airflow contaminated with particles; and
a plurality of internal data storage system components having component surfaces that are located in proximity to the rotatable data storage medium and within the airflow contaminated with particles; and
impact absorbing material positioned on at least one of the plurality of internal data storage system components, the impact absorbing material configured to reduce rebound velocity of the particles off of the at least one of the plurality of internal data storage system components.

12. The enclosure system of claim 11, wherein the impact absorbing material comprises a viscoelastic material.

13. The enclosure system of claim 11, wherein the impact absorbing material comprises a porous surface to further reduce rebound velocity of the particles off of the at least one of the plurality of internal data storage system components.

14. The enclosure system of claim 13, wherein the porous surface comprises apertures that have greater sizes than sizes of the particles.

15. A method of reducing rebound velocity of particles, the method comprising:
providing an enclosure including at least one rotatable storage medium and at least one internal component;
generating an airflow with the at least one rotatable storage medium, the airflow being subject to contamination by particles; and
applying an impact absorbing material to a surface of the at least one internal component that is orientated traversely to the airflow, the impact absorbing material reducing rebound velocity of the particles off of the at least one component in the enclosure.

16. The method of claim 15, wherein applying the impact absorbing material to the surface of the at least one internal component comprises applying the impact absorbing material to a portion of the surface of a shroud wall that is spaced radially outward from an edge of the at least one rotatable storage medium.

17. The method of claim 15, wherein applying the impact absorbing material to the surface of the at least one internal component comprises applying the impact absorbing material to a surface of an actuator mechanism that positions a transducing head relative to the at least one storage medium.

18. The method of claim 15, wherein applying the impact absorbing material to the surface of the at least one internal component comprises applying the impact absorbing material to an at least one storage medium separator plate positioned adjacent the at least one rotating storage medium and including a leading edge surface located downstream from an actuator mechanism that positions a transducing head relative to the at least one storage medium.

19. The method of claim 15, wherein applying the impact absorbing material to the surface of the at least one internal component comprises applying the impact absorbing material to a leading edge surface of an upstream air dam feature positioned adjacent the at least one rotating storage medium.

20. The method of claim 15, wherein applying the impact absorbing material to the surface of the at least one internal component comprises applying the impact absorbing material to a leading edge surface of a downstream air dam feature positioned adjacent the at lest one rotating storage medium.
